(19) United States
(12) Patent Application Publication
(10) Pub. No.: US 2024/0409327 A1
(43) Pub. Date: Dec. 12, 2024

(54) BATCH OBJECT HANDLING HEAD

(71) Applicant: DS SMITH PACKAGING FRANCE SAS, Puteaux (FR)

(72) Inventors: Thomas PAJOT, Dijon (FR); Arnaud GAILLOT, Dijon (FR)

(21) Appl. No.: 18/273,953

(22) PCT Filed: Jan. 25, 2022
(86) PCT No.: PCT/IB2022/050639

§ 371 Date: Jul. 24, 2023

(30) Foreign Application Priority Data
Jan. 26, 2021 (FR) FR2100723

(51) Int. Cl. B65G 47/91; B65B 21/06; B65B 21/20; B65B 35/38

(52) U.S. Cl. CPC B65G 47/918; B65B 21/06; B65B 21/20; B65B 35/38; B65G 2201/0244

(57) ABSTRACT

A handling head for handling objects in batches has a fixing member for fixing to a handling unit, a plurality of gripping heads, each intended to pick an object, and an operating member adapted to adjust a spacing between the gripping heads, the operating member having at least two beams parallel to each other, at least one linking arm pivotably connected to each beam so that pivoting of the linking arm with respect to each beam adjusts a transverse spacing between the beams, and a carriage fixed to each gripping head and connected in longitudinal translation to one of the beams. The operating member has, on the one hand, at least two transverse crosspieces to which the carriages are connected in transverse translation, each carriage being connected in translation to a beam and a crosspiece, and, on the other hand, a spacer comb for adjusting longitudinal spacing between the crosspieces.

The present invention generally relates to the technical field of batch object handling units, and more particularly to the field of batch object handling heads.

More specifically, the present invention relates to a head for handling batch objects which comprises a member for fixing it to a handling unit, a plurality of gripping heads extending along respective extension axes parallel to each other, each one being intended to pick up an object, and an operating member interposed between the fixing member and the gripping heads and adapted to adjust the spacing between said gripping heads,

wherein said operating member comprises:
at least two beams, parallel to each other, which extend in a longitudinal direction perpendicular to the extension axes of the gripping heads,
at least one linking arm linked in a pivoting manner to each beam so that pivoting of the linking arm relative to each beam adjusts the transverse spacing between the beams, and
a carriage fixed to each gripping head and linked in longitudinal translation to one of the beams.

We already know from document WO-0204327 such a head for manipulating batch objects, in which the objects are loaded along the beams so as to be in contact to each other, and in which the transverse spacing between the beams is adjustable to that the objects are compacted as much as possible, with a view to putting them on a pallet.

In the known batch object handling head, the objects are squeezed together along each beam. Such a manipulation head therefore does not make it possible to adjust the spacing between the objects along each beam.

JP H09 295 608 A discloses another known manipulation head.

The present invention aims at improving the known handling heads, for example in order to offer more freedom as to the adjustment of the spacing of the objects within the handled batch.

To this end, the present invention proposes a head for manipulating batch objects as described above, wherein the maneuvering member further comprises, on the one hand, at least two transverse crosspieces, parallel to each other, to which the carriages are linked in transverse translation so that each carriage is linked in translation both to a beam and to a crosspiece, and, on the other hand, means for adjusting the longitudinal spacing between the crosspieces, and wherein the means for adjusting the longitudinal spacing between the crosspieces comprise a spacing comb, the teeth of which are intended to be inserted between the crosspieces.

Thus, the manipulation head according to the invention makes it possible to adjust the spacing of the gripping heads in two directions, longitudinal and transverse, orthogonal to each other and to the axes of extension of the gripping heads. The adjustment of the gaps in the two directions is facilitated thanks to the present invention. Furthermore, the batch object handling head according to the present invention is designed so as to be light and easy to handle, and the spacing comb thus makes it possible to fix the longitudinal spacing between the crosspieces, and therefore the spacing longitudinal between the gripping heads within each beam.

According to an advantageous characteristic feature of the invention, the spacer comb is an independent part intended to be attached to the crosspieces. Thus, the spacing comb is attached to the crosspieces only once the spacing has been adjusted between the gripping heads so that the spacing comb does not weigh down the handling head when adjusting said spacing. The independent spacer comb contributes to the overall lightening of the manipulation head.

According to an advantageous characteristic feature of the invention, the teeth of the spacer comb are separated by notches spaced at a regular pitch. Thus, when the spacer comb cooperates with the crosspieces, these are all equidistant from each other. The manipulation head thus makes it possible to place the objects equidistant from each other within each beam. Alternatively, it is conceivable that the notches separating the teeth of the spacer comb are spaced at an irregular pitch, so that when the comb cooperates with the crosspieces, these are not all placed at the same distance from each other. The manipulation head arranged according to this variant makes it possible to take objects of different sizes within the same batch.

According to an advantageous characteristic feature of the invention, a different spacing comb is provided for each desired longitudinal spacing between the crosspieces. There are thus several separate combs to cooperate with the crosspieces, depending on the desired longitudinal spacing between said crosspieces. The fact of using a singular comb for each desired longitudinal spacing between the crosspieces simplifies the fixing of said longitudinal spacing without hindering the easy modification of this spacing which makes it possible to take objects of different sizes from one batch to another.

According to an advantageous characteristic feature of the invention, each carriage has one end forming a slider, adapted to move along a rail carried by the corresponding beam. Thus, each carriage is guided in translation along the beam to which it is linked, in particular when adjusting the longitudinal spacing between the crosspieces. In addition, each carriage is adapted to move along the beam to which it is linked, in a simple manner, without weighing down the handling head.

According to an advantageous characteristic feature of the invention, each carriage has a through-opening receiving the crosspiece relative to which said carriage is adapted to move. Thus, each carriage is guided in translation along the crosspiece to which it is linked, in particular when adjusting the transverse spacing between the beams. In addition, the guidance of each carriage along the corresponding crosspiece is carried out in a simple and light manner, which does not weigh down the handling head

According to an advantageous characteristic feature of the invention, the extension axes of the crosspieces extend in a plane parallel and distinct from that in which the extension axes of the beams extend. Thus, the adjustment of the transverse spacing between the beams is independent of the adjustment of the longitudinal spacing between the crosspieces. The adjustment of each transverse and longitudinal spacing is facilitated.

According to an advantageous characteristic feature of the invention, the maneuvering member comprises a fixed central beam and two movable lateral beams, interconnected by two linking arms parallel to each other so as to form, on either side of the central beam, two deformable parallelograms. Thus, the pivoting of the linking arms symmetrically modifies the transverse spacing between each side beam and the central beam. In other words, a single movement (the pivoting of the linking arms) makes it possible to simultaneously adjust the spacing between three beams.

It should be noted that the same principle of realization is also possible in the case of the implementation of an odd number of beams greater than three.

According to an advantageous characteristic feature of the invention, each one of the central and lateral beams receives part of the carriages. Thus, all the beams receive carriages so that the quantity of objects that the manipulation head can take within the same batch is increased.

According to an advantageous characteristic feature of the invention, the member for fixing to the handling unit is carried by the central beam. Thus, the central beam alone supports the fixing member. Such an embodiment makes it easier to mount the handling head on the handling unit while ensuring centering of the masses and avoiding weighing down the side beams, which facilitates adjustment of their transverse spacing.

According to an advantageous characteristic feature of the invention, each gripping head comprises gripping means connected in translation, in the direction of extension of the gripping head, to the carriage to which the gripping head is fixed. Thus, the head for manipulating objects in batches has a certain flexibility in the direction of extension (here vertical), which allows it to take fragile objects, and reduces the risk of breaking or dropping objects during their pick-up and/or drop-off.

According to an advantageous characteristic feature of the invention, the gripping means are generally cylindrical suction cup means intended to take the objects by suction. Such gripping means are particularly suitable for handling objects of different shapes. The gripping means are here particularly suitable for gripping bottles by the neck.

Of course, the different characteristic features, variants and embodiments of the invention can be associated with each other in various combinations insofar as they are not incompatible or exclusive of each other.

In addition, various other characteristic features of the invention emerge from the appended description made with reference to the drawings which illustrate non-limiting forms of embodiment of the invention and where:

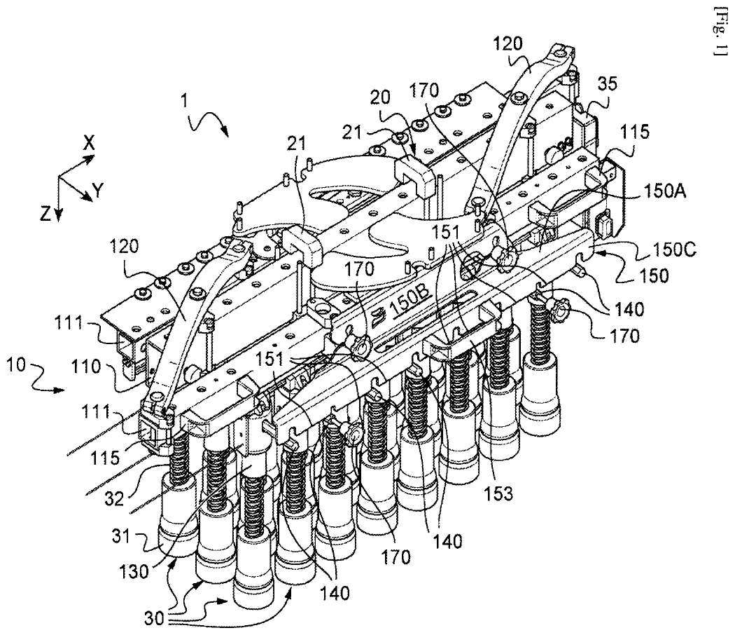

FIG. 1 is a front perspective view of a batch object handling head according to the invention, wherein the gripping heads are spaced apart to receive objects with 82 millimeters in diameter,

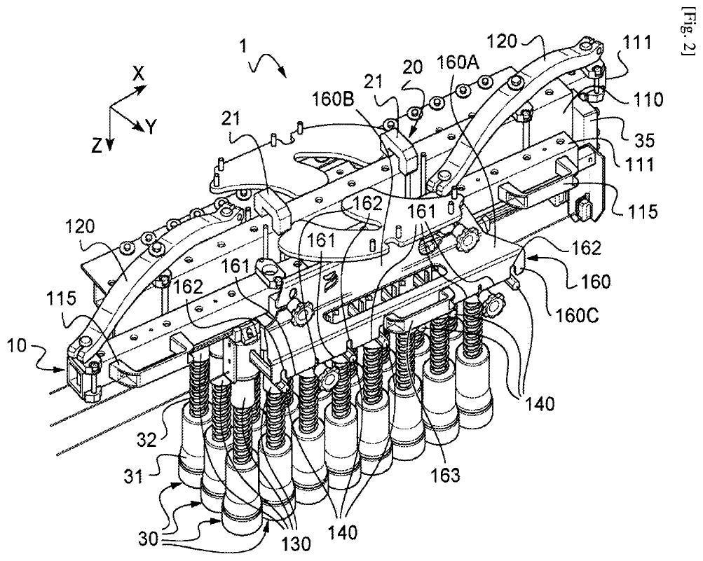

FIG. 2 is a front perspective view of the manipulation head of FIG. 1, wherein the gripping heads are spaced apart from each other to receive objects with 58 millimeters in diameter,

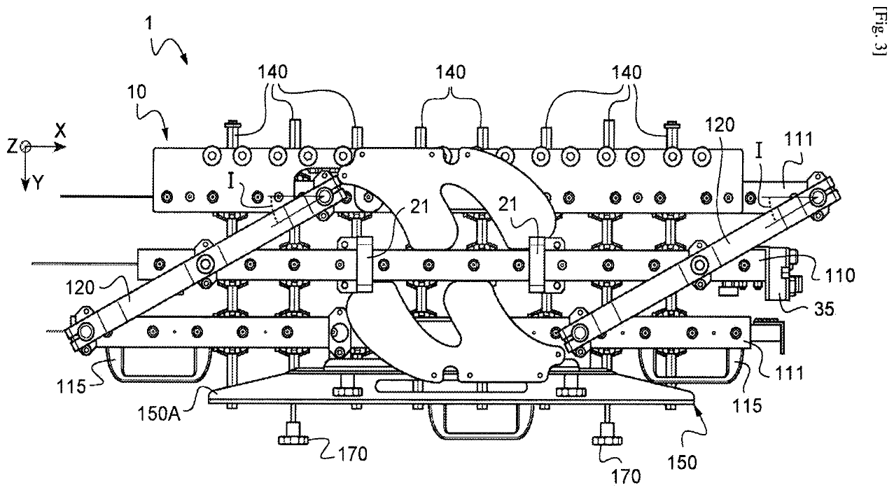

FIG. 3 is a top view of the manipulation head of FIG. 1,

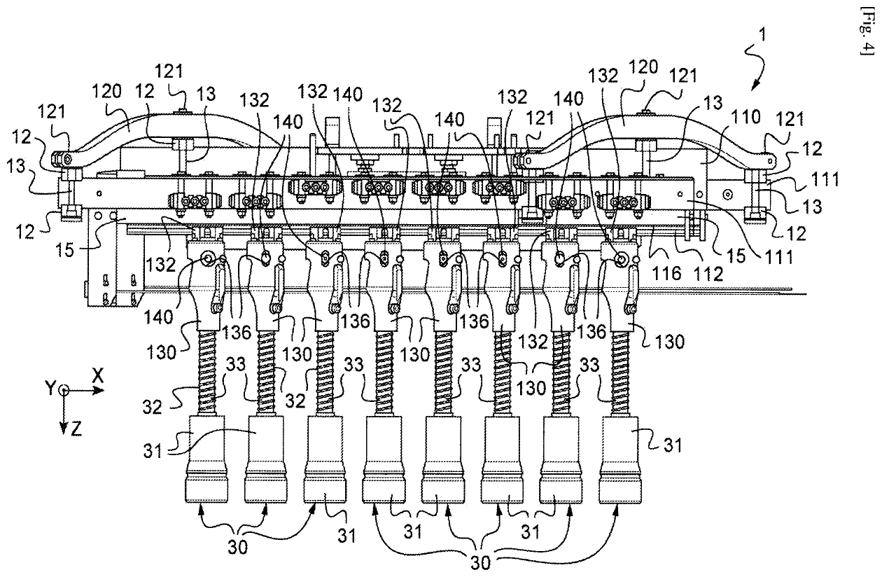

FIG. 4 is a rear view of the manipulation head of FIG. 1,

FIG. 5 is a side view of the manipulation head of FIG. 1,

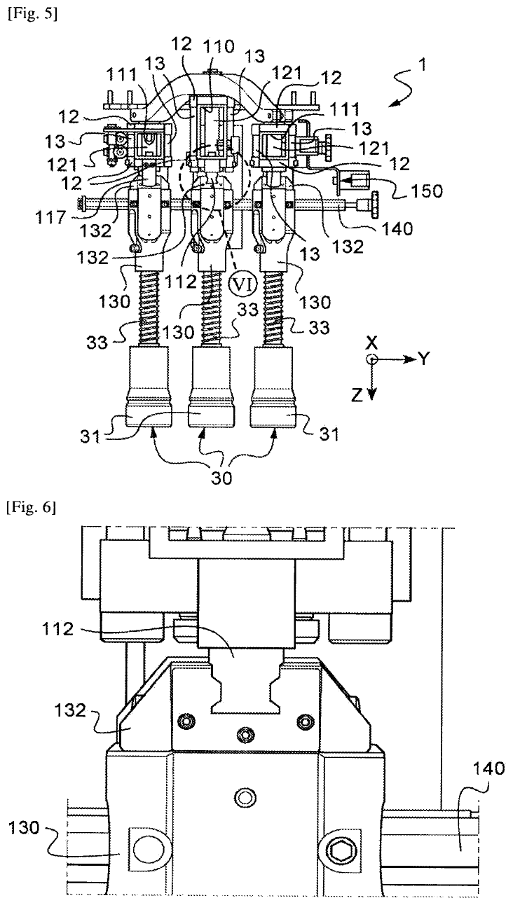

FIG. 6 is an enlarged view of part IV of FIG. 5, and

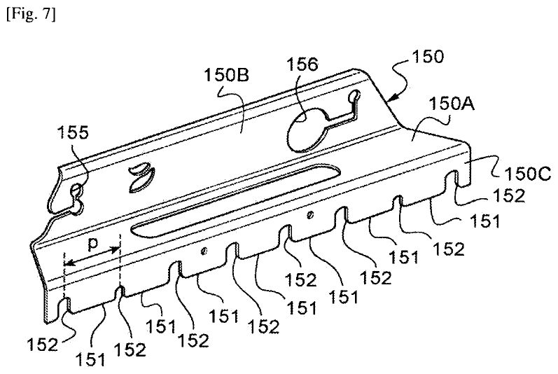

FIG. 7 is a view of the spacer comb of the manipulation head of FIG. 1.

The invention relates to a head 1 for handling objects in batches, as illustrated in FIGS. 1 to 5. Such a handling head 1 is intended to take up a plurality of objects (not shown) in order to move them from a point A to a point B. The handling head 1 of batch objects is particularly suitable for taking objects to put them on a pallet for transport.

As shown in FIGS. 1 and 2, the handling head 1 of batch objects comprises for this purpose, on the one hand, a fixing member 20 to a handling unit (not shown), and, on the other hand, a plurality of gripping heads 30 extending along respective extension axes Z parallel to each other.

The direction in which the extension axes Z of the gripping heads 30 extend is shown vertically in all of FIGS. 1 to 5. In practice, the vertical direction forms a trihedron with a longitudinal direction X and a transverse direction Y orthogonal to each other. By convention, in the rest of the description, the terms “lower” and “upper” will be defined with respect to the vertical direction. Thus, the term “lower” will designate a face of the manipulation head 1 turned towards the manipulated objects, while the term “upper” will designate a face of the manipulation head 1 turned away from them, that is to the handling unit.

As shown in FIG. 1, the gripping heads 30 are arranged at a lower end of the manipulation head 1, while the fixing member 20 is arranged at the upper end of the manipulation head 1. Each gripping head 30 is intended to take an object, so that the handling head 1 provided with the plurality of gripping heads 30 is adapted to take a batch of several objects.

In order to be able to adjust the spacing between the gripping heads 30, the handling head 1 of batch objects comprises an operating member 10, interposed between the fixing member 20 and said gripping heads 30 (see FIGS. 1 and 2). The maneuvering member 10 comprises a supporting structure from which the gripping heads 30 are here suspended, and means for adjusting the distance between the gripping heads 30.

As shown more specifically in FIGS. 1 to 3, the operating member 10 comprises:
at least two beams 110, 111, parallel to each other, which extend in the longitudinal direction X perpendicular to the extension axes Z of the gripping heads 30, and
at least one linking arm 120 pivotally linked to each beam 110, 111 so that the pivoting of the linking arm 120 with respect to each beam 110, 111 adjusts the transverse spacing between the beams 110, 111, and
a carriage 130 fixed to each gripping head 30 and linked in longitudinal translation to one of the beams 110, 111.

Here, the maneuvering member 10 comprises more precisely three beams, each one extending along its own extension axis, parallel to the longitudinal direction X. The three beams are arranged so as to form a fixed central beam 110 and two mobile side beams 111, interconnected by two linking arms 120 parallel to each other. This arrangement defines, on either side of the central beam 110, two deformable parallelograms (see FIG. 3).

The beams 110, 111 are made of rigid metallic material, which ensures their robustness for lifting large masses. In order to lighten the handling head 1 as much as possible, the metal beams 110, 111 are hollow (see FIGS. 1 and 5) or tubular. Each beam 110, 111 is thus formed by four metal walls: an upper wall, a lower wall and two side walls parallel to each other and perpendicular to said upper and lower walls.

The two parallel linking arms 120 are attached to the upper and lower walls of each beam 110, 111, by means of pivot rods 121 (see FIGS. 4 and 5) passing through said lower and upper walls and held to said walls by stirrups 12 and bolts 13 (see FIGS. 4 and 5). Each linking arm 120 is thus free to rotate with respect to each beam 110, 111, while driving during its pivoting the spacing of the side beams 111 with respect to the central beam 110.

The linking arms 120 are generally arcuate (see FIGS. 4 and 5) with a concavity facing the extension heads 30. This configuration facilitates the pivoting of the linking arms 120.

During the pivoting of the linking arms 120, the mobile side beams 111 are forced in translation along the transverse direction Y perpendicular to the longitudinal direction X and to the vertical direction. To do this, the side beams 111 are connected in a translational manner to at least one crosspiece 140 (see FIGS. 3 and 5) extending along an extension axis parallel to the transverse direction Y. This crosspiece 140 thus serves as guide to the transverse displacement of the side beams 111. Here, the side beams 111 are forced in translation not by one single crosspiece 140, but by a set of crosspieces 140 extending parallel to each other (see FIG. 3). In practice, the beams 110, 111 are linked in transverse translation to the set of crosspieces 140 by means of carriages 130 (see FIGS. 4 and 5).

As shown in FIG. 3, the two linking arms 120 are attached to the central beam 110 and the side beams 111 symmetrically with respect to the center of the central beam 110. This configuration balances the beams 110, 111 in particular during the pivoting of the linking arms 120.

Here, the pivoting of the linking arms 120 is automated. It is in particular controlled and controlled electronically, by a control unit 35, here arranged on the manipulation head 1 (see FIG. 2). Alternatively, it could be manually controlled by an operator.

As clearly shown in FIG. 3, in top view, the linking arm 120 forms an acute angle I with the extension axis of each beam 110, 111. The more this acute angle I increases towards a right angle, the more the transverse difference between the beams 110, 111 increases. For example, the acute angle formed between the linking arms 120 and the beams 110, 111 is greater in FIG. 1 than in FIG. 2, so that the beams 110, 111 are further apart from each other in FIG. 1 than in FIG. 2.

To adjust the transverse spacing between the beams 110, 111, the maneuvering member 10 of the manipulation head 1 comprises maneuvering means making it possible to adjust the acute angle I formed between the linking arms 120 and the beams 110, 111. For example, as shown in FIGS. 1 to 3, one of the side beams 111 comprises, on the one of its side walls that faces the outside of the manipulation head 1, at least one handle 115 on which an operator (human or robotic) can act. Here, two handles 115 are more particularly provided, one generally disposed at each end of the side beam 111. By pulling (respectively pushing) the handles 115, the operator spreads (respectively tightens) the side beam 111 to which the handles 115 of the central beam 110 are attached, which causes the pivoting of the linking arms 120, and the separation (respectively the tightening) symmetrical of the other side beam 111. The handles 115 are here in the form of a handle of a vessel, but could have any other form suitable for handling by an operator (human or robotic).

The gripping heads 30 are able to move, in particular along the beams 110, 111, by means of the mobile carriages 130 of the maneuvering member 10. Here, as shown in FIGS. 4 and 5, each gripping head 30 is associated with a respective carriage 130, so that the movement of a carriage 130 causes the movement of the single corresponding gripping head 30. As a variant, it could be envisaged that each carriage, or at least some of the carriages, supports several gripping heads, in which case the movement of this carriage causes the simultaneous movement of all the gripping heads associated with it.

“Carriage” is understood to mean a generic term which qualifies a part capable of moving relative to another part. Thus, a carriage within the meaning of the invention may optionally include wheels facilitating its movement, but this is not imperative.

Here, each carriage 130 is both fixed to one of the gripping heads 30 and linked in longitudinal translation to one of the beams 110, 111, that is to say that it is adapted to move along said beam 110, 111. More specifically, each carriage 130 is connected by its upper end to one of the beams 110, 111, and by its lower end to a connecting rod 33 of the gripping head 30, which connecting rod 33 bears at its lower end the gripping means 31 of the gripping head 30 (see FIGS. 4 and 5).

Here, each one of the central and lateral beams 110, 111 receives part of the carriages 130. More precisely, as clearly shown in FIGS. 1 and 2, the central and lateral beams 110, 111 each receive the same number of carriages 130, namely in this embodiment, eight carriages 130 each. The manipulation head 1 of batch objects represented in FIGS. 1 to 5 therefore comprises a total of twenty-four carriages 130 (see FIG. 1).

In order to be able to move relative to the beam 110, 111 to which it is attached, the upper end of each carriage 130 forms a slider 132, intended to slide along a rail 112 carried by the beam 110, 111 (see FIGS. 4 and 5). Thus, each carriage 130 is suspended from one of the beams 110, 111 via its slider 132, while being free to slide along said beam 110, 111.

As shown in FIGS. 4 to 6, each rail 112 is here a linear guide rail, known to those skilled in the art. The three rails 112 of the three beams 110, 111 are all identical.

Here, each rail 112 is carried by the underside of a beam 15 fixed under the lower wall of the corresponding beam 110, 111 (see FIG. 4). The beam 15 is split into sections to allow attachment of the linking arms 120 to the corresponding beam 110, 111, but receives a rail 112 which extends continuously from one end of the beam 110, 111 to the other. Beam 15 thus makes it possible to shift the rails 112 downwards so that the movement of the carriages 130 is not hindered by the mechanism making it possible to adjust the transverse spacing between the beams 110, 111. Preferably, there is provided a means of stopping, for example a stopping piece 117 (see FIG. 5) at the ends of at least one of the rails 112, so as to prevent the carriages 130 from leaving the rails 112 on which they are engaged.

It emerges from the foregoing that the transverse spacing between the beams 110, 111, adjusted via the linking arms 120, imposes the transverse spacing between the carriages of two distinct beams, and therefore the transverse spacing between the gripping heads 30 themselves, while the longitudinal movement of the carriages 130 in the rails 112 makes it possible to move the gripping heads 30 along each beam 110, 111.

Remarkably, the maneuvering member 10 not only makes it possible to move the carriages 130 longitudinally along the beams 130, but also makes it possible, thanks to the set of crosspieces 140 extending in the transverse direction Y, to adjust and to fix the longitudinal spacing between the gripping heads 30.

To do this, the operating member 10 comprises:
at least two of the crosspieces 140 of the set of crosspieces described above, to which the carriages 130 of different beams 110, 111 are linked in transverse translation (see FIGS. 1 and 2), and
means for adjusting the longitudinal spacing between said crosspieces 140.

Here, as shown in FIGS. 1 and 2, each crosspiece 140 is formed by a solid rod of metallic material, the longitudinal section of which (that is to say the section perpendicular to the transverse axis) has a hexagonal shape. The hexagonal shape associated with the metal material of the rods reinforces their robustness. The crosspieces could of course have a section of different shape.

In order to be able to move relatively to the crosspiece 140 to which it is linked, each carriage 130 here comprises a through-opening 136 receiving said crosspiece 140 (see FIG. 4). The through-opening 136 forms a guide for moving the carriage 130 along the crosspiece 140.

Here, the maneuvering member 10 more precisely comprises eight crosspieces 140 each one of which makes integral with each other three carriages 130 linked respectively to one of the three beams 110, 111. In other words, in top view (see FIG. 3), the beams 110, 111 and the crosspieces 140 form a mesh and one carriage 130 is provided at each node of this mesh.

Each carriage 130 is thus both linked in longitudinal translation to a beam 110, 111 and in transverse translation to a crosspiece 140, so that it can be moved, on the one hand, longitudinally (that is to say along one of the beams 110, 111) by the movement of one of the crosspieces 140, and, on the other hand, transversely (that is to say along one of the crosspieces 140) by the movement of the beams 110, 111.

Here, the through-opening 136 of the carriage 130 is provided in a central portion of the carriage 130, between its upper and lower ends respectively linked to a beam 110, 111 and to a gripping head 30 (see FIGS. 4 and 5). The extension axes of the crosspieces 140 thus extend in a plane parallel and distinct from that in which the extension axes of the beams 110, 111 extend. This configuration facilitates independent adjustments, on the one hand, of the transverse spacing between the gripping heads 30, via the beams 110, 111, and, on the other hand, the longitudinal spacing between the gripping heads 30, via the crosspieces 140.

To adjust the longitudinal spacing between two crosspieces 140, the carriages 130 crossed by the same crosspiece 140 are slid simultaneously along the rails 112 of the three beams 110, 111. The crosspiece 140 therefore forms a means of simultaneously maneuvering the carriages 130 which are united through it. Of course, the adjustment of the longitudinal spacing between the crosspieces 140 makes it possible to adjust the longitudinal spacing between the gripping heads 30 fixed to the carriages 130. This adjustment can be carried out by an operator (human or robotic).

Each crosspiece 140 therefore has a dual function, that of a guide for causing the transverse displacement of the beams 110, 111 during the pivoting of the linking arms 120, and that of an operating means for simultaneously moving the carriages 130 through which it passes.

It is important to note that for adjusting the transverse spacing between the beams 110, 111, it is preferable to fix the longitudinal spacing between the crosspieces 140, and for adjusting the longitudinal spacing between the crosspieces 140, it is preferable to fix the transverse spacing between the beams 110, 111.

For adjusting, and if necessary for fixing, the longitudinal spacing between the crosspieces 140, the operating member 10 advantageously comprises a spacing comb 150; 160 (see FIGS. 1, 2, and 7) the teeth 151; 161 of which are intended to be inserted between the crosspieces 140. The spacer comb 150; 160 forms a means for adjusting the longitudinal spacing between the crosspieces 140 and consequently between the gripping heads 30.

The spacer comb 150; 160 is an autonomous part intended to be attached to the crosspieces 140. The fact that it is autonomous contributes to the overall relief of the manipulation head 1, in particular when adjusting the transverse and/or longitudinal spacings between the gripping heads 30. Once the spacer comb 150; 160 mounted on the crosspieces 140, the latter are blocked by the teeth 151; 161 which prevent their movement in the longitudinal direction X.

Here, the spacer comb 150; 160 is a metal part, the profile of which forms a stair step (see FIGS. 5 and 7) or a “Z” shape. The spacer comb 150; 160 thus comprises three segments: a core 150A; 160A here shown horizontally, and two upper and lower wings 150B, 150C; 160B, 160C, here shown vertically (see FIGS. 2 and 7).

The core 150A; 160A is perforated in order to lighten the spacer comb 150, 160, while allowing the upper and lower wings 150B, 150C; 160B, 160C to be connected together (see FIGS. 3 and 7).

The lower wing 150C; 160C of the spacer comb 150; 160 is intended to be positioned at the level of the crosspieces 140 and carries the teeth 151; 161 which must be inserted between said crosspieces 140. The teeth 151; 161 of the spacer comb 150; 160 are separated from each other by notches 152; 162 intended to straddle the crosspieces 140 to block their longitudinal movement (see FIGS. 2 and 7). In other words, when the spacer comb 150; 160 is placed on the crosspieces 140, each notch 152; 162 cooperates with one of the crosspieces 140. The lower wing 150C; 160C is further provided with a handle 153; 163 (see FIGS. 1 and 2) to facilitate handling of the spacer comb 150; 160 by an operator (human or robotic) and its installation on the crosspieces 140.

The upper wing 150B; 160B of the spacer comb 150; 160 is intended to be positioned facing the side wall of the side beam 111 facing the operator (see FIGS. 1 and 2). The upper wing 150B; 160B comprises means for attachment to this side beam 111, for example in the form of notches 155, 156; 165, 166 (see FIG. 7).

Once the notches 152, 162 of the spacer comb 150; 160 are engaged with the crosspieces 140, it is possible to immobilize the spacer comb 150; 160 on the bearing structure of the operating member 10, respectively at the level of the side beam 111 and at the level of the crosspieces 140, via the upper and lower wings 150B, 150C; 160B, 160C. To do this, clamping screws, here for example knurled screws 170 (see FIGS. 1 and 3), are mounted at the ends of certain crosspieces and on the side beam 111 to clamp the comb 150; 160 on the supporting structure.

In practice, when positioning the spacer comb 150; 160 on the crosspieces 140, the knurled screws 170 fixed to the side beam 111 are inserted into notches 155, 156 provided in the upper wing 150B (see FIG. 7). The spacer comb 150; 160 is then movable longitudinally to position the teeth 151; 161 of the lower wing 150C; 160C of the spacer comb 150; 160 facing the interstices separating the crosspieces 140. In this position, the spacer comb 150; 160 is lowered so that the notches 152; 162 of the lower wing 150C; 160C come into engagement with the crosspieces 140. All the knurled screws 170 are then tightened to firmly hold the spacer comb 150; 160 in place.

Here, a different spacer comb 150; 160 is provided for each desired longitudinal spacing between the crosspieces 140. In this case, the combs 150; 160 respectively shown in FIGS. 1 and 2 are similar, only the spacing between the notches 152; 162 separating the teeth 151; 161 varies between the spacer combs 150; 160 represented. The spacing comb 150 represented in FIGS. 1 and 7 makes it possible to fix the spacing between the crosspieces 140 at a distance equal to approximately 82 millimeters, so that the manipulation head 1 is suitable for picking up objects (for example bottles) with 82 millimeters in diameter. The spacing comb 160 shown in FIG. 2 makes it possible to fix the spacing between the crosspieces 140 at a distance equal to about 58 millimeters, so that the handling head 1 is adapted to pick up objects (for example bottles) with 58 millimeters in diameter.

In each spacer comb 150; 160 shown, the notches 152; 162 separating the teeth 151; 161 are spaced at a regular pitch “p” (see FIG. 7). Here, the term “pitch”, denoted “p”, is understood to mean the distance separating the central axis from two consecutive notches. Here, the notches 152; 162 receiving the crosspieces 140 are respectively spaced apart by 82 millimeters or 58 millimeters.

Finally, from the point of view of the overall operation of the handling head 1, the fixing member 20 connecting the handling head 1 to the handling unit (not shown) is conventionally formed by two handles 21 in the form of a handle (see FIGS. 1 and 2). Here, the handles 21 of the fixing member 20 are attached above the upper wall of the central beam 110, in a central region of this beam 110. Clamps (not shown) provided on a robotic arm of the handling unit are intended to be hooked into these handles 21. The movement of the robotic arm to which the handling head 1 is thus hooked makes it possible to move all the objects of the batch taken by the gripping heads 30, in a single operation.

The gripping means 31 of each gripping head 30 are movable in translation along the extension axis Z. More specifically, the gripping means 31 are movable by means of the connecting rod 33 at the lower end of which they are fixed (see FIGS. 1, 2 and 4). This connecting rod 33 is rigid, and slidable in the vertical direction, between a rest position (shown in FIGS. 1 and 2 for example) in which it extends entirely outside the carriage 130 and a work position in which it sinks inside the carriage 130, for example when the gripping head 30 supports the object. The connecting rod 33 is surrounded by a compression spring 32 which permanently returns it to its rest position. Thus, all the gripping heads 30 extend at rest or under load at the same altitude. The connecting rod 33 slides in the carriage 130 and the spring 32 is compressed when the gripping means 31 come into contact with the object that the gripping head 30 is about to take. This mobile connection of the gripping means 31 offers flexibility at the handling head 1 when picking up and setting down the batch of objects, to compensate for any differences in levels between the objects. This configuration notably reduces the risk of breaking or dropping the objects when gripping them.

Here, the gripping means 31 are suction cup means of generally cylindrical shape. These suction cup means are suitable for picking up objects by suction and are well known to those skilled in the art. These suction cup means are connected to a source of depression or vacuum, here not shown to facilitate understanding of the figures. The suction is for example controlled by the control unit 35 (see FIGS. 1, 2 and 3) or by another control means not shown. Here, the gripping means 31 are particularly suitable, in particular thanks to their cylindrical shape, for taking the neck of a bottle by suction.

The invention is not limited to the embodiment described and modifications are possible.

In particular, the head for handling batch objects could be adapted to handle more or less large batches, and comprise more or fewer beams and/or more or fewer carriages on each beam, and/or more or fewer crosspieces, depending on the size of the batch to be handled.

It is also conceivable that certain nodes of the mesh formed by the beams and the crosspieces are devoid of carriages.

It is also conceivable that the spacer comb is provided with teeth separated by notches spaced apart from each other with an irregular pitch. Such an irregular comb makes it possible to handle, within the same batch, objects of various sizes.

As a further variant, it is also conceivable that a single spacing comb is suitable for fixing different longitudinal spacings (regular or irregular) between the crosspieces. Such a single spacer comb is provided with teeth whose width is adjustable, which amounts to being able to adjust the spacing pitch between the teeth.

It is also possible for the spacer comb to have many more teeth than there are crosspieces, so that several teeth are then inserted between two consecutive crosspieces. With such a comb, all the notches separating the teeth do not come into engagement with one of the crosspieces when the spacer comb is placed on the crosspieces, and certain notches are, on the contrary, unused.

Various other modifications may still be made to the invention within the scope of the appended claims.

1. A handling head for handling objects in batches, comprising a fixing member for fixing to a handling unit, a plurality of gripping heads extending along respective extension axes parallel to each other, each gripping head of the plurality of gripping heads being intended to pick up an object, and an operating member interposed between the fixing member and the gripping heads and adapted to adjust a spacing between said gripping heads,
wherein said operating member comprises:
at least two beams, parallel to each other, which extend in a longitudinal direction perpendicular to the extension axes of the gripping heads,
at least one linking arm pivotally linked to each beam so that pivoting of the linking arm with respect to each beam adjusts a transverse spacing between the beams, and
a carriage fixed to each gripping head and linked in longitudinal translation to one of the beams, and, on the one hand, at least two transverse crosspieces, parallel to each other, to which the carriages are connected in transverse translation, each carriage being connected in translation both to a beam of the at least two beams and to a crosspiece of the at least two transverse crosspieces, and, on the other hand, adjustment means for adjusting a longitudinal spacing between the crosspieces,
wherein the adjustment means for adjusting the longitudinal spacing between the crosspieces comprise a spacer comb whose teeth are intended to be inserted between the crosspieces.

2. The handling head of claim 1, wherein the spacer comb is an independent part intended to be attached to the crosspieces.

3. The handling head of claim 1, wherein the teeth of the spacer comb are separated by notches spaced at a regular pitch.

4. The handling head of claim 1, wherein a different spacer comb is provided for each desired longitudinal spacing between the crosspieces.

5. The handling head of claim 1, wherein each carriage comprises one end forming a slider adapted to move along a rail carried by a corresponding beam.

6. The handling head of claim 1, wherein each carriage comprises through-opening receiving the crosspiece relative to which the carriage is adapted to move.

7. The handling head of claim 1, wherein extension axes of the crosspieces extend in a plane parallel and distinct from that in which extension axes of the beams extend.

8. The handling head of claim 1, wherein the operating member comprises a fixed central beam and two movable lateral beams, interconnected by two linking arms parallel to each other so as to form, on either side of the fixed central beam, two deformable parallelograms.

9. The handling head of claim 8, wherein each one of the central and lateral beams receives part of the carriages.

10. The handling head of claim 8, wherein the fixing member is carried by the fixed central beam.

11. The handling head of claim 1, wherein each gripping head comprises gripping means linked in translation, in a direction of extension of the gripping head, to the carriage to which the gripping head is attached.

12. The handling head of claim 11, wherein the gripping means are suction cup means of cylindrical shape suitable for picking up the objects by suction.
